(19) United States
(12) Patent Application Publication
(10) Pub. No.: US 2025/0094534 A1
(43) Pub. Date: Mar. 20, 2025

(54) TASK EXECUTION METHOD AND APPARATUS FOR LARGE MODEL, ELECTRONIC DEVICE, AND STORAGE MEDIUM

(71) Applicant: Beijing Baidu Netcom Science Technology Co., Ltd., Beijing (CN)

(72) Inventors: Linhao ZHANG, Beijing (CN); Yilong CHEN, Beijing (CN); Junyuan SHANG, Beijing (CN); Yinqi YANG, Beijing (CN); Shuohuan WANG, Beijing (CN); Yu SUN, Beijing (CN)

(21) Appl. No.: 18/968,798

(22) Filed: Dec. 4, 2024

(30) Foreign Application Priority Data
May 31, 2024 (CN) 202410704057.3

(51) Int. Cl. G06F 17/16

(52) U.S. Cl. CPC G06F 17/16

(57) ABSTRACT

A task execution method for a large model relates to fields of artificial intelligence, deep learning and large model technologies, and includes executing attention tasks in a task group to be fused using a target computing unit to obtain attention features, where the attention task corresponds to a weighted matrix to be fused, the weighted matrix to be fused is obtained by weighting a matrix to be fused using a weight; obtaining a processing result according to the attention features; determining a loss information according to the processing result; and weighting and fusing matrices to be fused using the target computing unit according to weights for the task group to be fused if the loss information converges, to obtain a fusion matrix for a target task group, where a target task in the target task group is executed by the target computing unit according to the fusion matrix.

This application claims the benefit of priority to Chinese Patent Application No. 202410704057.3, filed on May 31, 2024. The entire contents of this application are hereby incorporated herein by reference.

### TECHNICAL FIELD

The present disclosure relates to a field of artificial intelligence technology, and in particular to fields of deep learning technology and large model technology. More specifically, the present disclosure provides a task execution method and apparatus for a large model, an electronic device, and a storage medium.

### BACKGROUND

With the development of artificial intelligence technology, data from various scenarios may be processed based on the attention mechanism.

### SUMMARY

The present disclosure provides a task execution method and apparatus for a large model, a device, and a storage medium.

According to an aspect of the present disclosure, a task execution method for a large model is provided, including: executing a plurality of attention tasks in at least one task group to be fused using a target computing unit, so as to obtain a plurality of attention features, where the attention task corresponds to one or more weighted matrices to be fused, and the one or more weighted matrices to be fused are obtained by weighting one or more matrices to be fused using one or more weights; obtaining a processing result using the target computing unit according to the plurality of attention features; determining a loss information using the target computing unit according to the processing result; and weighting and fusing a plurality of matrices to be fused for the at least one task group to be fused using the target computing unit according to a plurality of weights for the at least one task group to be fused in response to determining that the loss information converges, so as to obtain one or more fusion matrices for at least one target task group, where the target task group corresponds to the task group to be fused, and a target task in the target task group is executed by the target computing unit according to the one or more fusion matrices.

According to another aspect of the present disclosure, a task execution apparatus for a large model is provided, including: a storage unit; and a target computing unit configured to: read a plurality of matrices to be fused for at least one task group to be fused from the storage unit; execute a plurality of attention tasks in the at least one task group to be fused, so as to obtain a plurality of attention features, where the attention task corresponds to one or more weighted matrices to be fused, and the one or more weighted matrices to be fused are obtained by weighting one or more matrices to be fused using one or more weights; obtain a processing result according to the plurality of attention features; determine a loss information according to the processing result; weight and fuse a plurality of matrices to be fused for the at least one task group to be fused according to a plurality of weights for the at least one task group to be fused in response to determining that the loss information converges, so as to obtain one or more fusion matrices for at least one target task group, where the target task group corresponds to the task group to be fused, and a target task in the target task group is executed according to the one or more fusion matrices; and write the fusion matrix into the storage unit to replace the plurality of matrices to be fused.

According to another aspect of the present disclosure, a task execution device for a large model is provided, including the task execution apparatus provided by the present disclosure.

According to another aspect of the present disclosure, an electronic device is provided, including: at least one processor; and a memory communicatively connected to the at least one processor, where the memory stores instructions executable by the at least one processor, and the instructions, when executed by the at least one processor, are configured to cause the at least one processor to implement the method provided by the present disclosure.

According to another aspect of the present disclosure, a non-transitory computer-readable storage medium having computer instructions stored thereon is provided, where the computer instructions are configured to cause a computer to implement the method provided by the present disclosure.

It should be understood that content described in this section is not intended to identify key or important features in embodiments of the present disclosure, nor is it intended to limit the scope of the present disclosure. Other features of the present disclosure will be easily understood through the following description.

### BRIEF DESCRIPTION OF THE DRAWINGS

The accompanying drawings are used to understand the present disclosure better and do not constitute a limitation to the present disclosure, in which:

FIG. 1 is a schematic diagram of an exemplary system architecture to which a task execution method and apparatus for a large model can be applied according to an embodiment of the present disclosure;

FIG. 2 is a flowchart of a task execution method for a large model according to an embodiment of the present disclosure;

FIG. 3 is a schematic diagram of a plurality of task groups to be fused according to an embodiment of the present disclosure;

FIG. 4A is a schematic diagram of a matrix to be fused according to an embodiment of the present disclosure;

FIG. 4B is a schematic diagram of a fusion matrix according to an embodiment of the present disclosure;

FIG. 4C is a schematic diagram of a fusion matrix according to another embodiment of the present disclosure;

FIG. 5 is a schematic block diagram of a task execution apparatus for a large model according to an embodiment of the present disclosure;

FIG. 6 is a schematic block diagram of a task execution device for a large model according to an embodiment of the present disclosure; and

FIG. 7 is a block diagram of an electronic device for implementing a task execution method for a large model according to an embodiment of the present disclosure.

### DETAILED DESCRIPTION OF EMBODIMENTS

Exemplary embodiments of the present disclosure will be described below with reference to the accompanying drawings, which include various details of embodiments of the present disclosure to facilitate understanding and should be considered as merely exemplary. Therefore, those of ordinary skill in the art should realize that various changes and modifications may be made to embodiments described herein without departing from the scope and spirit of the present disclosure. Likewise, for clarity and conciseness, descriptions of well-known functions and structures are omitted in the following description.

In the field of deep learning, the application of large models is constantly expanding. However, the inference cost and deployment difficulty of large models are relatively high. Large models may include, for example, large language models (LLMs), large image models, and large audio models.

In some embodiments, the large model may perform inference based on multi-head self-attention (MHA) mechanism. The multi-head self-attention mechanism is a key technology in natural language processing and other sequence processing tasks. The multi-head self-attention mechanism is an extension of self-attention mechanism, which may enhance the expression and generalization ability of the model by computing a plurality of attention heads in parallel. Each attention head may independently learn a group of query parameter matrices, key parameter matrices, and value parameter matrices. These parameter matrices may be linear transformation matrices. Attention weights may be determined based on these parameter matrices. However, when performing inference based on the multi-head self-attention mechanism, large models need to maintain key-value cache, which leads to a large amount of storage resources being occupied, significantly increasing the complexity and cost of deploying and running large models. In addition, based on the multi-head self-attention mechanism, the model training effect is relatively excellent. However, in practical applications, especially in scenarios where hardware resources are limited, the high storage resource overhead increases the difficulty of model deployment.

In some other embodiments, in order to reduce the difficulty of model deployment, large models may use the group query attention (GQA) mechanism for inference. The group query attention mechanism may fuse a plurality of attention heads, significantly reducing the need for key-value cache during model inference. The group query attention mechanism is also an attention mechanism for natural language processing and sequence processing. The group query attention mechanism may group query features for processing and share the cache of corresponding key-value pairs. Therefore, each query group does not need to independently calculate and store all key-value pairs, but may use a shared cache, thereby reducing duplicate calculations and storage requirements. However, the group query attention mechanism involves averaging the outputs of the plurality of attention heads, which may reduce the storage resource overhead but also lower the performance of the model. In scenarios with strict requirements for model accuracy, the group query attention mechanism may not be able to meet usage desires.

In addition, if the multi-head self-attention mechanism is converted into the group query attention mechanism, the model needs to be retrained or restoratively trained to ensure that the model after mechanism conversion has similar performance to the model before conversion. However, retraining or restorative training requires a large amount of training data and computational resources, resulting in high conversion costs. In scenarios that require rapid iteration or deployment of a plurality of models, high conversion costs may limit the use and promotion of group query attention.

Therefore, in order to reduce the hardware resource overhead required for the attention mechanism conversion, the present disclosure provides a task execution method for a large model, which will be described below.

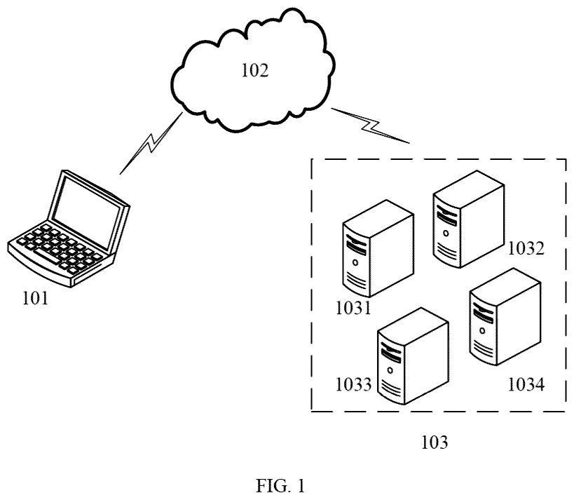

FIG. 1 is a schematic diagram of an exemplary system architecture to which a task execution method and apparatus for a large model can be applied according to an embodiment of the present disclosure.

It should be noted that the exemplary system architecture shown in FIG. 1 is only an example to which embodiments of the present disclosure may be applied, to help those skilled in the art understand the technical content of the present disclosure, but it does not mean that embodiments of the present disclosure may not be used in other devices, systems, environments or scenarios.

As shown in FIG. 1, a system architecture according to this embodiment may include a terminal device 101, a network 102, and a server cluster 103. The network 102 is used to provide a medium for communication links between the terminal device 101 and the server cluster 103. The network 102 may also be used to provide a medium for communication links within the server cluster 103. The network 102 may include various connection types, such as wired and/or wireless communication links, etc.

The terminal device 101 may be used by the user to interact with the server cluster 103 through the network 102 to receive or transmit messages etc. For example, the terminal device 101 may send a request for training a deep learning model to the server cluster 103 through the network 102.

Various communication client applications may be installed on the terminal device 101, such as knowledge reading applications, web browser applications, search applications, instant messaging tools, email clients, and/or social platform software, etc. (only examples).

The terminal device 101 may be any electronic device with a display screen and supporting web browsing, including but not limited to a smart phone, a tablet computer, a laptop computer, a desktop computers, etc.

The server cluster 103 may be a server that provides various services, such as a background management server (only an example) that provides support for the request sent by the user using the terminal device 101.

The server cluster 103 may be a cloud server, also referred to as a cloud computing server or a cloud host, which is a host product in the cloud computing service system to solve shortcomings of difficult management and weak business scalability in conventional physical host and VPS (Virtual Private Server) service. The server may also be a server of a distributed system, or a server combined with a blockchain.

The server cluster 103 includes a plurality of server nodes 1031, 1032, 1033, and 1034, each of which includes one or more hardware devices. The method provided in the present disclosure may be executed using one or more computing units of hardware devices in the server cluster 103 or the server nodes. Based on the task execution method for the large model provided in the present disclosure, the multi-head self-attention mechanism may be transformed into the group query attention mechanism using fewer computing and storage resources.

It may be understood that the system architecture of the present disclosure has been described above, and the method of the present disclosure will be described below.

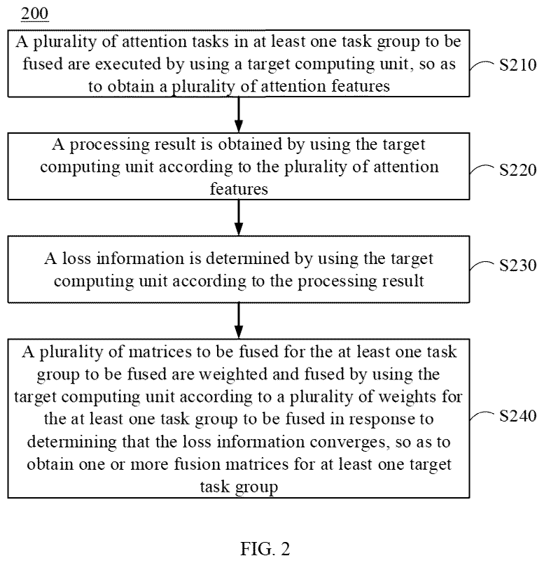

FIG. 2 is a flowchart of a task execution method for a large model according to an embodiment of the present disclosure.

As shown in FIG. 2, a method 200 may include operation S210 to operation S240.

In operation S210, a plurality of attention tasks in at least one task group to be fused are executed by using a target computing unit, so as to obtain a plurality of attention features.

In embodiments of the present disclosure, the attention task may be related to an attention head of a multi-head self-attention task in a transformer layer of a large model.

In embodiments of the present disclosure, the target computing unit may include at least one of a central processing unit (CPU), a graphics processing unit (GPU), or an artificial intelligence computing unit. The artificial intelligence computing unit may include at least one of a neural network processing unit (NPU), a tensor processing unit (TPU), or a Kunlun core.

In embodiments of the present disclosure, the task group to be fused may correspond to a plurality of attention heads of the multi-head self-attention mechanism. The multi-head self-attention mechanism may include H attention heads. H attention heads may be divided into Y groups. One or more groups of attention heads among the Y groups may correspond to one or more task groups to be fused. H may be an integer greater than 1. Y may be an integer greater than or equal to 1.

In embodiments of the present disclosure, the attention task corresponds to one or more weighted matrices to be fused, and the one or more weighted matrices to be fused are obtained by weighting one or more matrices to be fused using one or more weights. For example, the matrix to be fused may be a key matrix or a value matrix. It may be understood that, the key matrix and the value matrix may be the key parameter matrix and the value parameter matrix described above, respectively.

In embodiments of the present disclosure, the attention task may be an attention task executed using the query matrix, the key matrix, and the value matrix. At least one of the key matrix and the value matrix of the attention task may be used as the matrix to be fused.

In operation S220, a processing result is obtained by using the target computing unit according to the plurality of attention features.

For example, the target computing unit may decode the plurality of attention features to obtain the processing result.

In operation S230, a loss information is determined by using the target computing unit according to the processing result.

In embodiments of the present disclosure, the loss information may be determined using various methods. For example, the loss information may be determined using supervised, unsupervised, or semi-supervised methods. Taking the supervised method as an example, the loss information may be determined according to the processing result and a corresponding label.

In operation S240, a plurality of matrices to be fused for the at least one task group to be fused are weighted and fused by using the target computing unit according to a plurality of weights for the at least one task group to be fused, in response to determining that the loss information converges, so as to obtain one or more fusion matrices for at least one target task group.

In embodiments of the present disclosure, the loss information may include a loss value. If the loss value is less than or equal to a preset loss threshold, it may be determined that the loss information converges. The convergence of loss information may also be determined through other methods.

In embodiments of the present disclosure, the task group to be fused may correspond to a plurality of matrices to be fused. Each of the plurality of matrices to be fused may be weighted using the weight corresponding to that matrix to be fused. The weighted matrices to be fused are fused to obtain the fusion matrix. For example, the task group to be fused may correspond to two key matrices. Each key matrix may correspond to two key weights. After the loss information converges, each key matrix is weighted by using the two key weights corresponding to that key matrix, so as to obtain key weighted matrices. A key fusion matrix may be obtained by fusing (e.g. adding) the two key weighted matrices. For another example, the task group to be fused may correspond to two value matrices. Each value matrix may correspond to two value weights. After the loss information converges, each value matrix is weighted by using the two value weights corresponding to that value matrix, so as to obtain value weighted matrices. A value fusion matrix may be obtained by fusing (e.g. adding) the two value weighted matrices.

In embodiments of the present disclosure, the target task group corresponds to the task to be fused, and a target task in the target task group is executed by the target computing unit according to the one or more fusion matrices. For example, according to a plurality of query matrices, one key fusion matrix, and one value fusion matrix, the target computing unit may execute one or more target tasks. Therefore, only the fusion matrix may be stored, reducing the storage resource overhead required for storing a plurality of key matrices and a plurality of value matrices.

Through embodiments of the present disclosure, a plurality of tasks are executed using the target computing unit, the attention features and corresponding processing results are obtained, and the loss information is determined based on the processing results. When the loss information converges, the matrix to be fused is weighted using the weights used in the task execution. Therefore, a plurality of key matrices and/or a plurality of value matrices in the group are fused in a data-driven manner. The conversion of attention mechanism may be implemented by the target computing unit, reducing the dependence on preset rules or manually designed conversion methods. The attention mechanism may be adjusted through learning, which may adapt to the needs of related tasks in various scenarios and reduce labor costs. By fully considering the loss information during fusion, it is possible to reduce inference and storage costs while maintaining or even improving the performance of the target computing unit in executing tasks, effectively reducing the potential performance loss caused by the group query attention mechanism.

It may be understood that the above has used the convergence of loss information as an example to describe the present disclosure. The following will use the example of loss information not converging to describe the present disclosure.

In some embodiments, the above method further includes: adjusting the plurality of weights for the at least one task group to be fused in response to determining that the loss information does not converge, and returning to execute the attention task in the task group to be fused using the target computing unit.

For example, if the loss information does not converge, the weights are adjusted, and the above operation S210 is returned to execute operations S210 to S230 again, so as to obtain new loss information. Next, it is possible to determine whether the new loss information converges or not. Through embodiments of the present disclosure, the process of adjusting weights draws inspiration from machine learning and deep learning methods. Especially, reinforcement learning or meta learning may be used to reduce inference costs while maintaining or even improving the efficiency of the target computing unit in executing tasks, fully reducing the dependence on human expert knowledge, fully using the capabilities of computing devices, thereby improving the conversion efficiency of the attention mechanism.

It may be understood that the method of the present disclosure has been described above, and the task group to be fused of the present disclosure will be described below.

In some embodiments, M task groups to be fused may be provided. M may be an integer greater than or equal to 1.

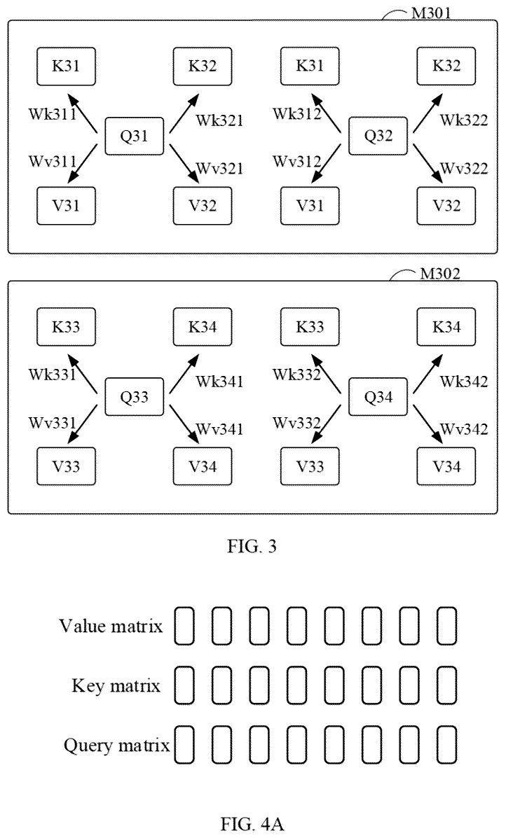

In embodiments of the present disclosure, the plurality of tasks in the task group to be fused may include N² tasks. N² tasks may include N² attention tasks executed using N query matrices, N key weighted matrices and N value weighted matrices. N is an integer greater than 1. For example, N may be 2, which will be described below in conjunction with FIG. 3. It may be understood that N=2 is only an example, and N may be any value greater than 1.

FIG. 3 is a schematic diagram of a plurality of task groups to be fused according to an embodiment of the present disclosure.

In embodiments of the present disclosure, the above method may further include: grouping a plurality of initial tasks using the target computing unit according to a grouping parameter, so as to obtain the at least one task group to be fused. For example, the grouping parameter may be 2. If the number of attention heads is 4, the 4 attention heads may be divided into two groups. Each attention head may correspond to one task group to be fused. As shown in FIG. 3, a task group M301 to be fused may correspond to a query matrix Q31, a query matrix Q32, a key matrix K31, a key matrix K32, a value matrix V31, and a value matrix V32. A task group M302 to be fused may correspond to a query matrix Q33, a query matrix Q34, a key matrix K33, a key matrix K34, a value matrix V33, and a value matrix V34. For the task group M301 to be fused, the key matrix K31, the key matrix K32, the value matrix V31, and the value matrix V32 may be used as the matrices to be fused. For the task group M302 to be fused, the key matrix K33, the key matrix K34, the value matrix V33, and the value matrix V34 may be used as the matrices to be fused. It may be understood that for the task group M301 to be fused, the query matrix Q31, the key matrix K31, and the value matrix V31 correspond to one attention head. The query matrix Q32, the key matrix K32, and the value matrix V32 correspond to one attention head. It may also be understood that, as shown in FIG. 3, M may be 2.

In embodiments of the present disclosure, the matrix to be fused for the task group to be fused may correspond to N weights. The task group to be fused may include a plurality of attention tasks. The plurality of attention tasks may correspond to N key matrices and N value matrices. For different attention tasks, the query matrices may be different, while the key matrices may be the same, and the value matrices may be the same. If N key matrices are used as N matrices to be fused, these N matrices to be fused may correspond to N weights, respectively. If N value matrices are used as N matrices to be fused, the N matrices to be fused may correspond to N weights, respectively. As shown in FIG. 3, the key matrix K31 corresponds to a key weight Wk311 and a key weight Wk312. The key matrix K32 corresponds to a key weight Wk321 and a key weight Wk322. The key matrix K33 corresponds to a key weight Wk331 and a key weight Wk332. The key matrix K34 corresponds to a key weight Wk341 and a key weight Wk342. The value matrix V31 corresponds to a value weight Wv311 and a value weight Wv312. The value matrix V32 corresponds to a value weight Wv321 and a value weight Wv322. The value matrix V33 corresponds to a value weight Wv331 and a value weight Wv332. The value matrix V34 corresponds to a value weight Wv341 and a value weight Wv342.

In embodiments of the present disclosure, N² tasks may include N² attention tasks executed by N query matrices, N key weighted matrices, and N value weighted matrices. For example, for the task group M301 to be fused, the four attention tasks include two attention tasks executed using the query matrix Q31 and two attention tasks executed using the query matrix Q32. The two attention tasks executed using the query matrix Q31 include: an attention task executed using the query matrix Q31, the key weight Wk311, the key matrix K31, the value weight Wv311, and the value matrix V31, and an attention task executed using the query matrix Q31, the key weight Wk321, the key matrix K32, the value weight Wv321, and the value matrix V32. The two attention tasks executed using the query matrix Q32 include: an attention task executed using the query matrix Q32, the key weight Wk312, the key matrix K31, the value weight Wv312, and the value matrix V31, and an attention task executed using the query matrix Q32, the key weight Wk322, the key matrix K32, the value weight Wv322, and the value matrix V32. It may be understood that a plurality of tasks in the task group M302 to be fused are similar to those in the task group M301 to be fused, which will not be repeated here. It may also be understood that the initial task may be a task executed using the query matrix, the key matrix, and the value matrix. For example, the initial task may be an attention task executed using the query matrix Q31, the key matrix K31, and the value matrix V31.

It may be understood that the task group to be fused of the present disclosure has been described above, and the method of executing a plurality of attention tasks in the task group to be fused will be described below.

In some embodiments, executing a plurality of attention tasks in at least one task group to be fused using a target computing unit so as to obtain a plurality of attention features may include: fusing a query feature with N key weighted features using the target computing unit, so as to obtain N fusion features.

In embodiments of the present disclosure, the query feature is obtained according to the query matrix and the data to be processed. The key weighted feature is obtained according to the key weighted matrix and the data to be processed. For example, the input feature may be obtained according to the data to be processed. The query feature may be obtained according to the query matrix and the input feature. The key weighted feature may be obtained according to the key weighted matrix and the input feature.

In embodiments of the present disclosure, fusing the query feature with N key weighted features using the target computing unit includes: fusing the query feature with N key weighted features using the target computing unit to obtain N intermediate fusion results. The N intermediate fusion results are normalized separately to obtain N fusion features. For example, the dimensionality of the key weighted feature may be used for normalization.

In some embodiments, executing a plurality of attention tasks in at least one task group to be fused using a target computing unit so as to obtain a plurality of attention features may further include: processing the N fusion features using the target computing unit based on a preset function, so as to obtain N intermediate features; and fusing the N intermediate features with N value weighted features respectively using the target computing unit, so as to obtain N attention features corresponding to the query feature.

In embodiments of the present disclosure, the value weighted feature is obtained according to the value weighted matrix and the data to be processed. The preset function may be a softmax function.

In embodiments of the present disclosure, the plurality of attention tasks in the task group to be fused may be implemented as the following equation:

$${Z}_{i j} = softmax ( \frac{( x * {Q}_{i} ) * {( x * W {k}_{i j} * {K}_{j} )}^{T}}{\sqrt{{d}_{k j}}} ) * ( x * W {v}_{i j} * {V}_{j} ) \qquad ( Equation 1 )$$

Zᵢⱼ may be the attention feature obtained by using the i^{th} query feature, the j^{th} key weighted feature, and the j^{th} value weighted feature. x*Qᵢ may be the i^{th} query feature. x*Wkᵢⱼ*Kⱼ may be the key weighted feature. x*Wvᵢⱼ*Vⱼ may be the value weighted feature. i may be an integer greater than or equal to 1 and less than or equal to N. j may be an integer greater than or equal to 1 and less than or equal to N. x may be the input feature. Qᵢ may be the i^{th} query matrix. Wkᵢⱼ may be the key weight. Kⱼ may be the j^{th} key matrix. dₖⱼ may be the dimension of the key matrix. Wvᵢⱼ may be the value weight. Vⱼ may be the j^{th} value matrix. For example, Qᵢ may be the query matrix Q31 described above. Correspondingly, Wkᵢⱼ may be the key weight Wk311 described above, Kⱼ may be the key matrix K31 described above, Wvᵢⱼ may be the value weight Wv311 described above, and Vi may be the value matrix V31 described above. For another example, Qᵢ may be the query matrix Q31 described above. Correspondingly, Wkᵢⱼ may also be the key weight Wk321 described above, Kⱼ may also be the key matrix K32 described above, Wvᵢⱼ may also be the value weight Wv321 described above, and Vⱼ may also be the value matrix V32 described above. Through embodiments of the present disclosure, attention tasks are executed by using a plurality of matrices to be fused in the task group to be fused and each query feature, which helps to accurately determine the weights used for matrix fusion and achieves the same or even improved efficiency and accuracy of task execution by the target computing unit.

It may be understood that some methods of executing the attention task in the present disclosure have been described above, and the following will describe some methods of obtaining the processing result.

In some embodiments, obtaining a processing result using the target computing unit according to the plurality of attention features includes: fusing the plurality of attention features using the target computing unit, so as to obtain an attention fusion feature; and obtaining the processing result using the target computing unit according to the attention fusion feature. For example, the N² attention features of the task group M301 to be fused and the N² attention features of the task group M302 to be fused may be fused to obtain the attention fusion feature. Next, the target computing unit may decode the attention fusion feature to obtain the processing result.

It may be understood that some methods of obtaining the processing result have been described above, and the following will describe some methods of determining the loss information.

In some embodiments, determining a loss information using the target computing unit according to the processing result includes: determining a task loss using the target computing unit according to the processing result and a label. For example, if the data to be processed is a query text input by the user, the processing result may be a response text corresponding to the query text, and the label may be a correct response corresponding to the query text. According to the processing result and the label, the task loss may be determined using various loss functions. The loss function may be, for example, a cross entropy loss function.

In some embodiments, determining a loss information using the target computing unit according to the processing result may further include: determining a plurality of parameter losses of each of the M task groups to be fused using the target computing unit according to the plurality of weights for each of the M task groups to be fused.

In embodiments of the present disclosure, the parameter loss indicates a difference between the N weights of the matrix to be fused.

In embodiments of the present disclosure, the number of parameter losses of the task group to be fused is N times the number of matrices to be fused corresponding to the attention tasks in the task group to be fused. For example, if both the key matrix and the value matrix in the attention task are used as matrices to be fused, the number of matrices to be fused corresponding to the attention task is 2, and the number of parameter losses may be 2N.

In embodiments of the present disclosure, the parameter loss is determined according to N weights corresponding to the matrix to be fused. As shown in FIG. 3, for the task group M301 to be fused, a parameter loss may be determined according to key weights Wk311 and Wk312, a parameter loss may be determined according to key weights Wk321 and Wk322, a parameter loss may be determined according to value weights Wv311 and Wv312, and a parameter loss may be determined according to value weights Wv321 and Wv322. It may be understood that for the task group M302 to be fused, 2N parameter losses may also be determined.

In embodiments of the present disclosure, the parameter loss may be determined according to the mean square error (MSE) loss function. It may be understood that the parameter loss may also be determined according to other loss functions.

In some embodiments, determining a loss information using the target computing unit according to the processing result may further include: determining the loss information using the target computing unit according to the task loss and the plurality of parameter losses.

In embodiments of the present disclosure, the plurality of parameter losses are fused using the target computing unit, so as to obtain a parameter fusion loss; the parameter fusion loss is processed using the target computing unit according to an adjustable parameter, so as to obtain a processed parameter fusion loss; and the loss information is determined using the target computing unit according to the processed parameter fusion loss and the task loss. Through embodiments of the present disclosure, the weight may be further adjusted if the parameter fusion loss is small and difficult to be fully optimized to zero, which facilitates to achieve lossless conversion of attention mechanisms and effectively reduces mechanism conversion costs, thereby achieving a balance between the task execution performance and the computational resource overhead.

It may be understood that some methods of determining the loss information have been described above. The following will take the convergence of loss information as an example to describe the present disclosure.

In some embodiments, weighting and fusing a plurality of matrices to be fused of the at least one task group to be fused using the target computing unit according to a plurality of weights for the at least one task group to be fused in response to determining that the loss information converges so as to obtain one or more fusion matrices of at least one target task group may include: weighting and fusing N matrices to be fused using the target computing unit according to N weights of each of the N matrices to be fused, so as to obtain the fusion matrix for the target task group. For example, if the loss information converges, each matrix to be fused is weighted by using N weights corresponding to that matrix to be fused, so as to obtain a weighted matrix. Next, N weighted matrices may be fused to obtain a fusion matrix. It may be understood that matrices to be fused of the same type may be weighted and fused. For example, a plurality of key matrices may be fused, or a plurality of value matrices may be fused, which will be described below.

In embodiments of the present disclosure, weighting and fusing N matrices to be fused using the target computing unit may include: weighting and fusing N key matrices using the target computing unit according to N key weights of each of the N key matrices, so as to obtain the key fusion matrix for the target task group. The key matrix is weighted by using N key weights corresponding to the key matrix. If the loss information determined by the parameter loss converges, there is almost no difference between the N key weights corresponding to the key matrix. The key matrix may be weighted using any one of the N key weights. As shown in FIG. 3, if the loss information converges, the key matrix K31 may be weighted using the key weight Wk311 to obtain a key weighted matrix. Alternatively, the key matrix K32 may be weighted using the key weight Wk321 to obtain another key weighted matrix. The key fusion matrix may be obtained by fusing the two key weighted matrices.

In embodiments of the present disclosure, weighting and fusing N matrices to be fused using the target computing unit may further include: weighting and fusing the N value matrices using the target computing unit according to the N value weights of each of the N value matrices, so as to obtain the value fusion matrix for the target task group. The value matrix is weighted by using at least one of the N value weights corresponding to the value matrix. If the loss information determined by the parameter loss converges, there is almost no difference between the N value weights corresponding to the value matrix. The value matrix may be weighted using any one of the N value weights. As shown in FIG. 3, if the loss information converges, the value matrix V31 may be weighted using the value weight Wv311 to obtain a value weighted matrix. Alternatively, the value matrix V32 may be weighted using the value weight Wv321 to obtain another value weighted matrix. The value fusion matrix may be obtained by fusing the two value weighted matrices.

In embodiments of the present disclosure, the weight corresponding to the matrix to be fused may be a weight matrix. Different elements in the weight matrix may be different values.

It may be understood that the above has used the convergence of loss information as an example to describe the present disclosure. The following will use the example of loss information not converging to describe the present disclosure.

In some embodiments, the plurality of weights for the at least one task group to be fused or the adjustable parameter may be adjusted in response to determining that the loss information does not converge; and the plurality of attention tasks in at least one task group to be fused may be executed using the target computing unit.

For example, the adjustable parameter may be the Lagrange multiplier. The loss value [symbol] of the loss information may be optimized by the following equation:

$$ℒ = {min}_{θ} {max}_{α} {ℒ}_{θ}^{l m} + α * {ℒ}_{θ}^{m s e} \qquad ( Equation 2 )$$

[symbol] _{θ}^{lm} may be the task loss. [symbol] _{θ}^{mse} may be the parameter fusion loss. α may be the adjustable parameter. The method of adjusting the loss information may include: reducing the task loss [symbol] _{θ}^{lm} and the parameter fusion loss [symbol] _{θ}^{mse}, and increasing the adjustable parameter α. Through embodiments of the present disclosure, weights are adjusted based on the Lagrangian optimization to accelerate the convergence of loss information. Therefore, weights may be efficiently adjusted in situations where computing resources are limited. Resource consumption (time overhead, training data requirements, etc.) and task execution performance (accuracy, response time, etc.) may be quantified, and the number of adjustments to weights and adjustable parameters may be effectively reduced, accelerating the convergence of loss information and making the optimization process more precise. This method is more suitable for application scenarios that require optimizing a plurality of model versions in a shorter period of time, which helps to achieve optimization under effective data resource conditions.

It may be understood that some implementation methods of the task execution method for the large model has been described above, and the fusion matrix of the present disclosure will be described below.

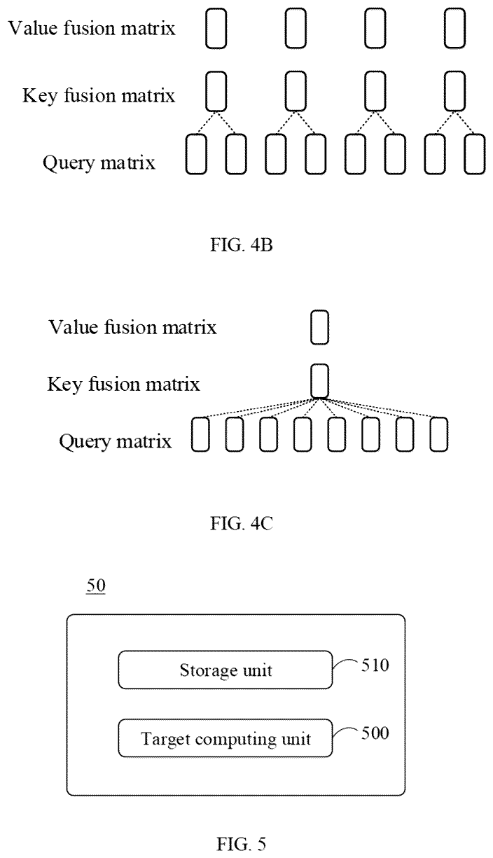

FIG. 4A is a schematic diagram of a matrix to be fused according to an embodiment of the present disclosure.

As shown in FIG. 4A, there may be 8 query matrices, 8 key matrices, and 8 value matrices. The key matrix may be used as the matrix to be fused. The value matrix may also be used as the matrix to be fused.

FIG. 4B is a schematic diagram of a fusion matrix according to an embodiment of the present disclosure.

As shown in FIG. 4B, 8 key matrices may be fused into 4 key fusion matrices. 8 value matrices may also be fused into 4 value fusion matrices. It may be understood that as shown in FIG. 4B, M may be 4.

FIG. 4C is a schematic diagram of a fusion matrix according to another embodiment of the present disclosure.

As shown in FIG. 4C, 8 key matrices may also be fused into 1 key fusion matrix. 8 value matrices may also be fused into 1 value fusion matrix. It may be understood that, as shown in FIG. 4C, M may be 1.

It may be understood that the above has used one or more matrices to be fused of attention tasks, including the key matrix and the value matrix, as an example to describe the present disclosure. However, the present disclosure is not limited to this. One or more matrices to be fused may include a key matrix, which will be described below.

In embodiments of the present disclosure, the plurality of tasks in the task group to be fused may be N² tasks. N² tasks may include N² attention tasks executed using the N query matrices, the N key weighted matrices and N value matrices. For example, N may be 2.

In embodiments of the present disclosure, the above method may further include: grouping a plurality of initial tasks using the target computing unit according to a grouping parameter, so as to obtain the at least one task group to be fused. For example, the grouping parameter may be 2. If the number of attention heads is 4, the 4 attention heads may be divided into two groups to obtain two task groups to be fused. Each group of attention heads may correspond to one task group to be fused. Two task groups to be fused may include a first task group to be fused and a second task group to be fused. The first task group to be fused may correspond to a first query matrix, a second query matrix, a first key matrix, a second key matrix, a first value matrix, and a second value matrix. The second task group to be fused may correspond to a third query matrix, a fourth query matrix, a third key matrix, a fourth key matrix, a third value matrix, and a fourth value matrix. The first key matrix and the second key matrix may be used as the matrices to be fused. The third key matrix and the fourth key matrix may also be used as the matrices to be fused. It may be understood that for the first task group to be fused, the first query matrix, the first key matrix, and the first value matrix correspond to one attention head. The second query matrix, the second key matrix, and the second value matrix correspond to another attention head. It may be understood that M=2.

In embodiments of the present disclosure, the matrix to be fused of the task group to be fused may correspond to N weights. The task group to be fused may include a plurality of attention tasks. The plurality of attention tasks may correspond to N key matrices and N value matrices. For different attention tasks, the query matrices may be different, while the key matrices may be the same, and the value matrices may be the same. If N key matrices are used as N matrices to be fused, the N key matrices may correspond to N key weights, respectively. For example, in the case of M=2, the first key matrix corresponds to two first key weights. The second key matrix corresponds to two second key weights. The third key matrix corresponds to two third key weights. The fourth key matrix corresponds to two fourth key weights.

In embodiments of the present disclosure, N² tasks may include: N² attention tasks executed using the N query matrices, the N key weighted matrices and N value matrices. For example, for the first task group to be fused, four attention tasks include: two attention tasks executed using the first query matrix and two attention tasks executed using the second query matrix. The two attention tasks executed using the first query matrix include: an attention task executed using the first query matrix, the first key weight, the first key matrix, and the first value matrix, and an attention task executed using the first query matrix, the second key weight, the second key matrix, and the second value matrix. The two attention tasks executed using the second query matrix include: an attention task executed using the second query matrix, the first key weight, the first key matrix, and the first value matrix, and an attention task executed using the second query matrix, the second key weight, the second key matrix, and the second value matrix. It may be understood that a plurality of tasks in the second task group to be fused are similar to those in the first task group to be fused, which will not be repeated here. It may also be understood that the initial task may be a task executed using the query matrix, the key matrix, and the value matrix. For example, the initial task may be an attention task executed using the first query matrix, the first key matrix, and the first value matrix.

It may be understood that the task group to be fused of the present disclosure has been described above, and the method of executing a plurality of attention tasks in the task group to be fused will be described below.

In some embodiments, executing a plurality of attention tasks in at least one task group to be fused using a target computing unit so as to obtain a plurality of attention features may include: fusing a query feature with N key weighted features using the target computing unit, so as to obtain N fusion features.

In embodiments of the present disclosure, the query feature is obtained according to the query matrix and the data to be processed. The key weighted feature is obtained according to the key weighted matrix and the data to be processed. For example, the input feature may be obtained according to the data to be processed. The query feature may be obtained according to the query matrix and the input feature. The key weighted feature may be obtained according to the key weighted matrix and the input feature.

In embodiments of the present disclosure, fusing the query feature with N key weighted features using the target computing unit includes: fusing the query feature with N key weighted features using the target computing unit to obtain N intermediate fusion results. The N intermediate fusion results are normalized separately to obtain N fusion features. For example, the dimensionality of the key weighted feature may be used for normalization.

In some embodiments, executing the plurality of attention tasks in at least one task group to be fused using the target computing unit so as to obtain the plurality of attention features may further include: processing N fusion features using the target computing unit based on a preset function, so as to obtain N intermediate features. The N intermediate features are fused with N value features respectively using the target computing unit, so as to obtain N attention features corresponding to the query feature. The value feature may be obtained according to the value matrix and the input feature.

In embodiments of the present disclosure, the preset function may be a softmax function.

In embodiments of the present disclosure, the plurality of attention tasks in the task group to be fused may be implemented as a first equation similar to the Equation (1) described above. Unlike the Equation (1) above, in the case where one or more matrices to be fused include a key matrix, the first equation may not include Wvᵢⱼ in the Equation (1). Through embodiments of the present disclosure, attention tasks are executed by using a plurality of key matrices in the task group to be fused and each query feature, which facilitates the accurately determination of the weights used for key matrix fusion and achieves the same or even improved efficiency and accuracy of task execution by the target computing unit. It may also save the computational resources required for matrix fusion.

It may be understood that some methods of executing the attention task in the present disclosure have been described above, and the following will describe some methods of obtaining the processing result.

In some embodiments, obtaining a processing result using the target computing unit according to the plurality of attention features includes: fusing the plurality of attention features using the target computing unit, so as to obtain an attention fusion feature; and obtaining the processing result using the target computing unit according to the attention fusion feature. For example, the N² attention features of the first task group to be fused and the N² attention features of the second task group to be fused may be fused to obtain the attention fusion feature. Next, the target computing unit may decode the attention fusion feature to obtain the processing result.

It may be understood that some methods of obtaining the processing result have been described above, and the following will describe some methods of determining the loss information.

In some embodiments, determining a loss information using the target computing unit according to the processing result includes: determining a task loss using the target computing unit according to the processing result and a label. For example, if the data to be processed is a query text input by the user, the processing result may be a response text corresponding to the query text, and the label may be a correct response corresponding to the query text. According to the processing result and the label, the task loss may be determined using various loss functions. The loss function may be, for example, a cross entropy loss function.

In some embodiments, determining a loss information using the target computing unit according to the processing result may further include: determining a plurality of parameter losses of each of the M task groups to be fused using the target computing unit according to the plurality of weights for each of the M task groups to be fused.

In embodiments of the present disclosure, the parameter loss may also indicate the difference between N weights of the key matrix.

In embodiments of the present disclosure, the number of parameter losses of the task group to be fused is N times the number of matrices to be fused corresponding to the attention tasks in the task group to be fused. For example, if the key matrix in the attention task is used as the matrix to be fused, the number of matrices to be fused corresponding to the attention task is 1, and the number of parameter losses of the corresponding task group to be fused may be N.

In embodiments of the present disclosure, the parameter loss is determined according to N weights corresponding to the matrix to be fused. For the first task group to be fused, the parameter loss may be determined according to two first key weights. The parameter loss may be determined according to two second key weights. It may be understood that for the second task group to be fused, N parameter losses may also be determined.

In embodiments of the present disclosure, the parameter loss may be determined according to the mean square error loss function. It may be understood that the parameter loss may also be determined according to other loss functions.

In some embodiments, determining a loss information using the target computing unit according to the processing result may further include: determining the loss information using the target computing unit according to the task loss and the plurality of parameter losses.

In embodiments of the present disclosure, the plurality of parameter losses are fused using the target computing unit so as to obtain a parameter fusion loss; the parameter fusion loss is processed using the target computing unit according to an adjustable parameter, so as to obtain a processed parameter fusion loss; and the loss information is determined using the target computing unit according to the processed parameter fusion loss and the task loss.

It may be understood that some methods of determining the loss information have been described above. The following will take the convergence of loss information as an example to describe the present disclosure.

In some embodiments, weighting and fusing a plurality of matrices to be fused of the at least one task group to be fused using the target computing unit according to a plurality of weights for the at least one task group to be fused in response to determining that the loss information converges so as to obtain one or more fusion matrices of at least one target task group includes: weighting and fusing N matrices to be fused using the target computing unit according to N weights of each of the N matrices to be fused, so as to obtain the fusion matrix for the target task group.

In embodiments of the present disclosure, weighting and fusing N matrices to be fused using the target computing unit may include: weighting and fusing the N key matrices using the target computing unit according to the N key weights of each of the N key matrices, so as to obtain the key fusion matrix for the target task group. The key matrix is weighted by using the N key weights corresponding to the key matrix. If the loss information determined by the parameter loss converges, there is almost no difference between the N key weights corresponding to the key matrix. The key matrix may be weighted using any one of the N key weights. When the loss information converges, the first key matrix may be weighted using the first key weight to obtain a key weighted matrix. Alternatively, the second key matrix may be weighted using the second key weight to obtain another key weighted matrix. The key fusion matrix may be obtained by fusing the two key weighted matrices.

In embodiments of the present disclosure, the key weight may be the key weight matrix. Different elements in the key weight matrix may be different values.

It may be understood that the above has used the convergence of loss information as an example to describe the present disclosure. The following will use the example of loss information not converging to describe the present disclosure.

In some embodiments, the plurality of weights for the at least one task group to be fused or the adjustable parameter may be adjusted in response to determining that the loss information does not converge; and the plurality of attention tasks in at least one task group to be fused may be executed using the target computing unit. For example, the key weight and the adjustable parameter may be adjusted based on the above Equation (2).

It may be understood that the above has used one or more matrices to be fused, including a key matrix, as an example to describe the present disclosure. However, the present disclosure is not limited to this. The following will illustrate the present disclosure by taking the matrix to be fused, including a value matrix, as an example.

In embodiments of the present disclosure, the plurality of tasks in the task group to be fused may be N² tasks. N² tasks may include N² attention tasks executed using the N query matrices, N key matrices and the N value weighted matrices. For example, N may be 2, which will be described below.

In embodiments of the present disclosure, the above method may further include: grouping a plurality of initial tasks using the target computing unit according to a grouping parameter, so as to obtain the at least one task group to be fused. For example, the grouping parameter may be 2. If the number of attention heads is 4, the 4 attention heads may be divided into two groups to obtain two task groups to be fused. Each group of attention heads may correspond to one task group to be fused. Two task groups to be fused may include a third task group to be fused and a fourth task group to be fused. The third task group to be fused may correspond to a fifth query matrix, a sixth query matrix, a fifth key matrix, a sixth key matrix, a fifth value matrix, and a sixth value matrix. The fourth task group to be fused may correspond to a seventh query matrix, an eighth query matrix, a seventh key matrix, an eighth key matrix, a seventh value matrix, and an eighth value matrix. The fifth value matrix and the sixth value matrix may be used as the matrices to be fused. The seventh value matrix and the eighth value matrix may also be used as the matrices to be fused. It may be understood that for the third task group to be fused, the fifth query matrix, the fifth key matrix, and the fifth value matrix correspond to one attention head; the sixth query matrix, the sixth key matrix, and the sixth value matrix correspond to one attention head. It may be understood that M may be 2.

In embodiments of the present disclosure, the matrix to be fused of the task group to be fused may correspond to N weights. The task group to be fused may include a plurality of attention tasks. The plurality of attention tasks may correspond to N key matrices and N value matrices. For different attention tasks, the query matrices may be different, while the key matrices may be the same, and the value matrices may be the same. If N value matrices are used as N matrices to be fused, these N value matrices may correspond to N value weights, respectively. For example, in the case of M=2, the fifth value matrix corresponds to two first value weights. The sixth value matrix corresponds to two second value weights. The seventh value matrix corresponds to two third value weights. The eighth value matrix corresponds to two fourth value weights.

In embodiments of the present disclosure, N² tasks may include: N² attention tasks executed using the N query matrices, the N key matrices and N value weighted matrices. For example, for the third task group to be fused, four attention tasks include: two attention tasks executed using the fifth query matrix and two attention tasks executed using the sixth query matrix. The two attention tasks executed using the fifth query matrix include: an attention task executed using the fifth query matrix, the fifth key matrix, the first value weight, and the fifth value matrix, and an attention task executed using the fifth query matrix, the sixth key matrix, the second value weight, and the sixth value matrix. The two attention tasks executed using the sixth query matrix include: an attention task executed using the sixth query matrix, the fifth key matrix, the first value weight, and the first value matrix, and an attention task executed using the sixth query matrix, the sixth key matrix, the second value weight, and the sixth value matrix. It may be understood that a plurality of tasks in the fourth task group to be fused are similar to those in the third task group to be fused, which will not be repeated here.

It may be understood that the task group to be fused of the present disclosure has been described above, and the method of executing a plurality of attention tasks in the task group to be fused will be described below.

In some embodiments, executing a plurality of attention tasks in at least one task group to be fused using a target computing unit so as to obtain a plurality of attention features may include: fusing a query feature with N key features using the target computing unit, so as to obtain N fusion features.

In embodiments of the present disclosure, the query feature is obtained according to the query matrix and the data to be processed. The key feature is obtained according to the key matrix and the data to be processed. For example, the input feature may be obtained according to the data to be processed. The query feature may be obtained according to the query matrix and the input feature. The key feature may be obtained according to the key matrix and the input feature.

In embodiments of the present disclosure, fusing the query feature with N key features using the target computing unit includes: fusing the query feature with N key features using the target computing unit to obtain N intermediate fusion results. The N intermediate fusion results are normalized separately to obtain N fusion features. For example, the dimensionality of the key feature may be used for normalization.

In some embodiments, executing a plurality of attention tasks in at least one task group to be fused using a target computing unit so as to obtain a plurality of attention features may further include: processing the N fusion features using the target computing unit based on a preset function, so as to obtain N intermediate features; and fusing the N intermediate features with N value weighted features respectively using the target computing unit, so as to obtain N attention features corresponding to the query feature.

In embodiments of the present disclosure, the value weighted feature is obtained according to the value weighted matrix and the data to be processed. The preset function may be a softmax function.

In embodiments of the present disclosure, the plurality of attention tasks in the task group to be fused may be implemented as a second equation similar to the Equation (1) described above. Unlike the Equation (1) above, in the case where one or more matrices to be fused include a value matrix, the second equation may not include Wkᵢⱼ in the Equation (1). Through embodiments of the present disclosure, attention tasks are executed by using a plurality of value matrices in the task group to be fused and each query feature, which facilitates the accurately determination of the weights used for value matrix fusion and achieves the same or even improved efficiency and accuracy of task execution by the target computing unit. It may also save the computational resources required for matrix fusion.

It may be understood that some methods of executing the attention task in the present disclosure have been described above, and the following will describe some methods of obtaining the processing result.

In some embodiments, obtaining a processing result using the target computing unit according to the plurality of attention features includes: fusing the plurality of attention features using the target computing unit, so as to obtain an attention fusion feature; and obtaining the processing result using the target computing unit according to the attention fusion feature. For example, the N² attention features of the third task group to be fused and the N² attention features of the fourth task group to be fused may be fused to obtain the attention fusion feature. Next, the target computing unit may decode the attention fusion feature to obtain the processing result.

It may be understood that some methods of obtaining the processing result have been described above, and the following will describe some methods of determining the loss information.

In some embodiments, determining a loss information using the target computing unit according to the processing result includes: determining a task loss using the target computing unit according to the processing result and a label. For example, if the data to be processed is a query text input by the user, the processing result may be an response text corresponding to the query text, and the label may be a correct answer corresponding to the query text. According to the processing result and the label, the task loss may be determined using various loss functions. The loss function may be, for example, a cross entropy loss function.

In some embodiments, determining a loss information using the target computing unit according to the processing result may further include: determining a plurality of parameter losses of each of the M task groups to be fused using the target computing unit according to the plurality of weights for each of the M task groups to be fused.

In embodiments of the present disclosure, the parameter loss indicates a difference between the N weights of the matrix to be fused.

In embodiments of the present disclosure, the number of parameter losses of the task group to be fused is N times the number of matrices to be fused corresponding to the attention tasks in the task group to be fused. For example, if the value matrix in the attention task is used as the matrix to be fused, the number of matrices to be fused corresponding to the attention task is 1, and the number of parameter losses may be N.

In embodiments of the present disclosure, the parameter loss is determined according to N weights corresponding to the matrix to be fused. As shown in FIG. 3, for the third task group 1 to be fused, the parameter loss may be determined according to two first value weights. The parameter loss may be determined according to two second value weights. It may be understood that for the fourth task group to be fused, N parameter losses may also be determined.

In embodiments of the present disclosure, the parameter loss may be determined according to the mean square error loss function. It may be understood that the parameter loss may also be determined according to other loss functions.

In some embodiments, determining a loss information using the target computing unit according to the processing result may further include: determining the loss information using the target computing unit according to the task loss and the plurality of parameter losses.

In embodiments of the present disclosure, the plurality of parameter losses are fused using the target computing unit, so as to obtain a parameter fusion loss; the parameter fusion loss is processed using the target computing unit according to an adjustable parameter, so as to obtain a processed parameter fusion loss; and the loss information is determined using the target computing unit according to the processed parameter fusion loss and the task loss.

It may be understood that some methods of determining the loss information have been described above. The following will take the convergence of loss information as an example to describe the present disclosure.

In some embodiments, weighting and fusing a plurality of matrices to be fused of the at least one task group to be fused using the target computing unit according to a plurality of weights for the at least one task group to be fused in response to determining that the loss information converges so as to obtain one or more fusion matrices of at least one target task group includes: weighting and fusing N matrices to be fused using the target computing unit according to N weights of each of the N matrices to be fused, so as to obtain the fusion matrix for the target task group.

In embodiments of the present disclosure, weighting and fusing N matrices to be fused using the target computing unit may include: weighting and fusing the N value matrices using the target computing unit according to the N value weights of each of the N value matrices, so as to obtain the value fusion matrix for the target task group. The value matrix is weighted by using at least one of the N value weights corresponding to the value matrix. If the loss information determined by the parameter loss converges, there is almost no difference between the N value weights corresponding to the value matrix. The value matrix may be weighted using any one of the N value weights. For example, if the loss information converges, the fifth value matrix may be weighted using the first value weight to obtain a value weighted matrix. Alternatively, the sixth value matrix may be weighted using the second value weight to obtain another value weighted matrix. The value fusion matrix may be obtained by fusing the two value weighted matrices.

In embodiments of the present disclosure, the value weight may be the value weight matrix. Different elements in the value weight matrix may be different values.

It may be understood that the above has used the convergence of loss information as an example to describe the present disclosure. The following will use the example of loss information not converging to describe the present disclosure.

In some embodiments, the plurality of weights for the at least one task group to be fused or the adjustable parameter may be adjusted in response to determining that the loss information does not converge; and the plurality of attention tasks in at least one task group to be fused may be executed using the target computing unit. For example, the value weight and the adjustable parameter may be adjusted based on the above Equation (2).

It may be understood that the plurality of initial tasks may be a plurality of tasks corresponding to one transformer layer. The data to be processed may be the initial data. The input feature may be determined according to the initial data. The data to be processed may also be the output feature after executing the plurality of tasks of a transformer layer. The input feature of the subsequent transformer layer may be determined according to that output feature.

It may be understood that the text data is used as an example of data to be processed above to describe the present disclosure. However, the present disclosure is not limited to this. The data to be processed may also be image data or image features. Alternatively, the data to be processed may also be audio data or audio features.

It may be understood that the method of the present disclosure has been described above, and the apparatus of the present disclosure will be described below.

FIG. 5 is a schematic block diagram of a task execution apparatus for a large model according to an embodiment of the present disclosure.

As shown in FIG. 5, an apparatus 50 may include a storage unit 510 and a target computing unit 500.

The storage unit 510 may be used to store the query matrix, the key matrix, and the value matrix for executing the attention task.

The target computing unit 500 is used to: read a plurality of matrices to be fused for at least one task group to be fused from the storage unit; execute a plurality of attention tasks in the at least one task group to be fused, so as to obtain a plurality of attention features; obtain a processing result according to the plurality of attention features; determine a loss information according to the processing result; weight and fuse a plurality of matrices to be fused for the at least one task group to be fused according to a plurality of weights for the at least one task group to be fused in response to determining that the loss information converges, so as to obtain one or more fusion matrices for at least one target task group; and write the fusion matrix into the storage unit to replace the plurality of matrices to be fused. It may be understood that the above method 200 may be executed using the target computing unit 500.

In embodiments of the present disclosure, the attention task corresponds to one or more weighted matrices to be fused, and the one or more weighted matrices to be fused are obtained by weighting one or more matrices to be fused using one or more weights.

In embodiments of the present disclosure, the target task group corresponds to the task group to be fused, and a target task in the target task group is executed according to the one or more fusion matrices.

In some embodiments, the target computing unit is further used to: adjust the plurality of weights for the at least one task group to be fused in response to determining that the loss information does not converge, and return to execute the plurality of attention tasks in at least one task group to be fused.

In some embodiments, the one or more matrices to be fused include at least one of a key matrix and a value matrix, the one or more weights include at least one of a key weight and a value weight, the one or more weighted matrices to be fused include at least one of a key weighted matrix and a value weighted matrix, the key weighted matrix is obtained by weighting the key matrix using the key weight, and the value weighted matrix is obtained by weighting the value matrix using the value weight, and the one or more fusion matrices include at least one of a key fusion matrix and a value fusion matrix.

In some embodiments, the plurality of attention tasks in the task group to be fused include: N² attention tasks executed using N query matrices, N key weighted matrices and N value weighted matrices, where Nis an integer greater than 1; and/or N² attention tasks executed using the N query matrices, the N key weighted matrices and N value matrices; and/or N² attention tasks executed using the N query matrices, N key matrices and the N value weighted matrices.

In some embodiments, the one or more matrices to be fused include the key weighted matrix and the value weighted matrix. The target computing unit is further used to execute the following operations to execute the plurality of attention tasks in at least one task group to be fused so as to obtain the plurality of attention features: fusing a query feature with N key weighted features, so as to obtain N fusion features, where the query feature is obtained according to a query matrix and data to be processed, and the key weighted feature is obtained according to the key weighted matrix and the data to be processed; processing the N fusion features based on a preset function, so as to obtain N intermediate features; and fusing the N intermediate features with N value weighted features respectively, so as to obtain N attention features corresponding to the query feature, where the value weighted feature is obtained according to the value weighted matrix and the data to be processed.

In some embodiments, the one or more matrices to be fused include the key weighted matrix. The target computing unit is further used to execute the following operations to execute the plurality of attention tasks in at least one task group to be fused so as to obtain the plurality of attention features: fusing a query feature with N key weighted features, so as to obtain N fusion features, where the query feature is obtained according to a query matrix and data to be processed, and the key weighted feature is obtained according to the key weighted matrix and the data to be processed; processing the N fusion features based on a preset function, so as to obtain N intermediate features; and fusing the N intermediate features with N value features respectively, so as to obtain N attention features corresponding to the query feature, where the value feature is obtained according to the value matrix and the data to be processed.

In some embodiments, the one or more matrices to be fused include the value weighted matrix. The target computing unit is further used to execute the following operations to execute the plurality of attention tasks in at least one task group to be fused so as to obtain the plurality of attention features: fusing a query feature with N key features, so as to obtain N fusion features, where the query feature is obtained according to a query matrix and data to be processed, and the key feature is obtained according to the key matrix and the data to be processed; processing the N fusion features based on a preset function, so as to obtain N intermediate features; and fusing the N intermediate features with N value weighted features respectively, so as to obtain N attention features corresponding to the query feature, where the value weighted feature is obtained according to the value weighted matrix and the data to be processed.

In some embodiments, the target computing unit is further used to execute the following operations to obtain the processing result according to the plurality of attention features: fusing the plurality of attention features using the target computing unit, so as to obtain an attention fusion feature; and obtaining the processing result using the target computing unit according to the attention fusion feature.

In some embodiments, the matrix to be fused for the task group to be fused corresponds to N weights, M task groups to be fused are provided, and M is an integer greater than or equal to 1. The target computing unit is further configured to execute the following operations to determine the loss information according to the processing result; determining a task loss according to the processing result and a label; determining a plurality of parameter losses of each of the M task groups to be fused according to the plurality of weights for each of the M task groups to be fused, where the parameter loss indicates a difference between the N weights of the matrix to be fused; and determining the loss information according to the task loss and the plurality of parameter losses.

In some embodiments, the target computing unit is further used to execute the following operations to determine the loss information according to the task loss and the plurality of parameter losses: fusing the plurality of parameter losses, so as to obtain a parameter fusion loss; processing the parameter fusion loss according to an adjustable parameter, so as to obtain a processed parameter fusion loss; and determining the loss information according to the processed parameter fusion loss and the task loss.

In some embodiments, the target computing unit is further used to: adjust the adjustable parameter in response to determining that the loss information does not converge, and return to execute the plurality of attention tasks in at least one task group to be fused.

In some embodiments, the target computing unit is further used to execute the following operations to weight and fuse the plurality of matrices to be fused for the at least one task group to be fused according to a plurality of weights for the at least one task group to be fused, so as to obtain one or more fusion matrices for at least one target task group: weighting and fusing N matrices to be fused according to N weights of each of the N matrices to be fused, so as to obtain the fusion matrix for the target task group.

In some embodiments, the target computing unit is further used to execute at least one of the following operations to weight and fuse N matrices to be fused: weighting and fusing N key matrices according to N key weights of each of the N key matrices, so as to obtain the key fusion matrix for the target task group, where the key matrix is weighted by using at least one of the N key weights corresponding to the key matrix; or weighting and fusing N value matrices according to N value weights of each of the N value matrices, so as to obtain the value fusion matrix for the target task group, where the value matrix is weighted by using at least one of the N value weights corresponding to the value matrix.

In some embodiments, the target computing unit is further used to: group a plurality of initial tasks according to a grouping parameter, so as to obtain the at least one task group to be fused.

It may be understood that the apparatus of the present disclosure has been described above, and the task execution device including the apparatus will be described below.

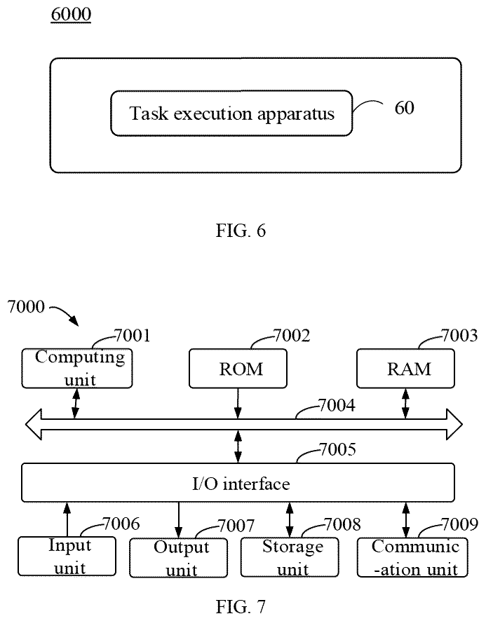

FIG. 6 is a schematic block diagram of a task execution device for a large model according to an embodiment of the present disclosure.

As shown in FIG. 6, a device 6000 may include a task execution apparatus 60. The task execution apparatus 60 may be the above-described apparatus 50.

In the technical solution of the present disclosure, the collection, storage, use, processing, transmission, provision, and disclosure of user personal information involved comply with relevant laws and regulations, and do not violate public order and good customs.

According to embodiments of the present disclosure, the present disclosure further provides an electronic device, a readable storage medium and a computer program product.

FIG. 7 schematically shows a block diagram of an electronic device 7000 used to implement embodiments of the present disclosure. The electronic device is intended to represent various forms of digital computers, such as a laptop computer, a desktop computer, a workstation, a personal digital assistant, a server, a blade server, a mainframe computer, and other suitable computers. The electronic device may further represent various forms of mobile devices, such as a personal digital assistant, a cellular phone, a smart phone, a wearable device, and other similar computing devices. The components as illustrated herein, and connections, relationships, and functions thereof are merely examples, and are not intended to limit the implementation of the present disclosure described and/or required herein.

As shown in FIG. 7, the device 7000 may include a computing unit 7001, which may perform various appropriate actions and processing based on a computer program stored in a read-only memory (ROM) 7002 or a computer program loaded from a storage unit 7008 into a random access memory (RAM) 7003. Various programs and data required for the operation of the device 7000 may be stored in the RAM 7003. The computing unit 7001, the ROM 7002 and the RAM 7003 are connected to each other through a bus 7004. An input/output (I/O) interface 7005 is further connected to the bus 7004.

Various components in the device 7000, including an input unit 7006 such as a keyboard, a mouse, etc., an output unit 7007 such as various types of displays, speakers, etc., a storage unit 7008 such as a magnetic disk, an optical disk, etc., and a communication unit 7009 such as a network card, a modem, a wireless communication transceiver, etc., are connected to the I/O interface 7005. The communication unit 7009 allows the device 7000 to exchange information/data with other devices through a computer network such as the Internet and/or various telecommunication networks.

The computing unit 7001 may be various general-purpose and/or special-purpose processing components with processing and computing capabilities. Some examples of the computing unit 7001 include but are not limited to a central processing unit (CPU), a graphics processing unit (GPU), various dedicated artificial intelligence (AI) computing chips, various computing units running machine learning model algorithms, a digital signal processor (DSP), and any appropriate processor, controller, microcontroller, and so on. The computing unit 7001 may perform the various methods and processes described above, such as the task execution method for the large model. For example, in some embodiments, the task execution method for the large model may be implemented as a computer software program that is tangibly contained on a machine-readable medium, such as the storage unit 7008. In some embodiments, part or all of a computer program may be loaded and/or installed on the device 7000 via the ROM 7002 and/or the communication unit 7009. When the computer program is loaded into the RAM 7003 and executed by the computing unit 7001, one or more steps of the task execution method for the large model described above may be performed. Alternatively, in other embodiments, the computing unit 7001 may be used to perform the task execution method for the large model in any other appropriate way (for example, by means of firmware).

Various embodiments of the systems and technologies described herein may be implemented in a digital electronic circuit system, an integrated circuit system, a field programmable gate array (FPGA), an application specific integrated circuit (ASIC), an application specific standard product (ASSP), a system on chip (SOC), a complex programmable logic device (CPLD), a computer hardware, firmware, software, and/or combinations thereof. These various embodiments may be implemented by one or more computer programs executable and/or interpretable on a programmable system including at least one programmable processor. The programmable processor may be a special-purpose or general-purpose programmable processor, which may receive data and instructions from the storage system, the at least one input device and the at least one output device, and may transmit the data and instructions to the storage system, the at least one input device, and the at least one output device.

Program codes for implementing the method of the present disclosure may be written in any combination of one or more programming languages. These program codes may be provided to a processor or a controller of a general-purpose computer, a special-purpose computer, or other programmable data processing devices, so that when the program codes are executed by the processor or the controller, the functions/operations specified in the flowchart and/or block diagram may be implemented. The program codes may be executed completely on the machine, partly on the machine, partly on the machine and partly on the remote machine as an independent software package, or completely on the remote machine or the server.

In the context of the present disclosure, the machine readable medium may be a tangible medium that may contain or store programs for use by or in combination with an instruction execution system, device or apparatus. The machine readable medium may be a machine-readable signal medium or a machine-readable storage medium. The machine readable medium may include, but not be limited to, electronic, magnetic, optical, electromagnetic, and infrared or semiconductor systems, devices or apparatuses, or any suitable combination of the above. More specific examples of the machine readable storage medium may include electrical connections based on one or more wires, portable computer disks, hard disks, random access memory (RAM), read-only memory (ROM), erasable programmable read-only memory (EPROM or flash memory), optical fiber, convenient compact disk read-only memory (CD-ROM), optical storage device, magnetic storage device, or any suitable combination of the above.

In order to provide interaction with users, the systems and techniques described here may be implemented on a computer including a display device (for example, a CRT (cathode ray tube) or LCD (liquid crystal display) monitor) for displaying information to the user), and a keyboard and a pointing device (for example, a mouse or a trackball) through which the user may provide the input to the computer. Other types of devices may also be used to provide interaction with users. For example, a feedback provided to the user may be any form of sensory feedback (for example, visual feedback, auditory feedback, or tactile feedback), and the input from the user may be received in any form (including acoustic input, voice input or tactile input).

The systems and technologies described herein may be implemented in a computing system including back-end components (for example, a data server), or a computing system including middleware components (for example, an application server), or a computing system including front-end components (for example, a user computer having a graphical user interface or web browser through which the user may interact with the implementation of the system and technology described herein), or a computing system including any combination of such back-end components, middleware components or front-end components. The components of the system may be connected to each other by digital data communication (for example, a communication network) in any form or through any medium. Examples of the communication network include a local area network (LAN), a wide area network (WAN), and Internet.

The computer system may include a client and a server. The client and the server are generally far away from each other and usually interact through a communication network. The relationship between the client and the server is generated through computer programs running on the corresponding computers and having a client-server relationship with each other.

It should be understood that steps of the processes illustrated above may be reordered, added or deleted in various manners. For example, the steps described in the present disclosure may be performed in parallel, sequentially, or in a different order, as long as a desired result of the technical solution of the present disclosure may be achieved. This is not limited in the present disclosure.

The above-described specific embodiments do not constitute a limitation on the scope of protection of the present disclosure. Those skilled in the art should understand that various modifications, combinations, sub-combinations and substitutions may be made according to design requirements and other factors. Any modifications, equivalent replacements and improvements made within the spirit and principles of the present disclosure shall be contained in the scope of protection of the present disclosure.

What is claimed is:

1. A task execution method for a large model, comprising:
executing a plurality of attention tasks in at least one task group to be fused using a target computing unit, so as to obtain a plurality of attention features, wherein the attention task corresponds to one or more weighted matrices to be fused, and the one or more weighted matrices to be fused are obtained by weighting one or more matrices to be fused using one or more weights;
obtaining a processing result using the target computing unit according to the plurality of attention features;
determining a loss information using the target computing unit according to the processing result; and
weighting and fusing a plurality of matrices to be fused for the at least one task group to be fused using the target computing unit according to a plurality of weights for the at least one task group to be fused in response to determining that the loss information converges, so as to obtain one or more fusion matrices for at least one target task group, wherein the target task group corresponds to the task group to be fused, and a target task in the target task group is executed by the target computing unit according to the one or more fusion matrices.

2. The method according to claim 1, further comprising:
adjusting the plurality of weights for the at least one task group to be fused in response to determining that the loss information does not converge, and returning to execute the plurality of attention tasks in the at least one task group to be fused using the target computing unit.

3. The method according to claim 1, wherein the one or more matrices to be fused comprise at least one of a key matrix and a value matrix, the one or more weights comprise at least one of a key weight and a value weight, the one or more weighted matrices to be fused comprise at least one of a key weighted matrix and a value weighted matrix, the key weighted matrix is obtained by weighting the key matrix using the key weight, and the value weighted matrix is obtained by weighting the value matrix using the value weight, and
wherein the one or more fusion matrices comprise at least one of a key fusion matrix and a value fusion matrix.

4. The method according to claim 3, wherein the plurality of attention tasks in the task group to be fused comprise:
N² attention tasks executed using N query matrices, N key weighted matrices and N value weighted matrices, wherein N is an integer greater than 1; and/or
N² attention tasks executed using N query matrices, N key weighted matrices and N value matrices; and/or
N² attention tasks executed using N query matrices, N key matrices and N value weighted matrices.

5. The method according to claim 3, wherein the one or more matrices to be fused comprise the key weighted matrix and the value weighted matrix,
wherein the executing a plurality of attention tasks in at least one task group to be fused using a target computing unit so as to obtain a plurality of attention features comprises:
fusing a query feature with N key weighted features using the target computing unit, so as to obtain N fusion features, wherein the query feature is obtained according to a query matrix and data to be processed, and the key weighted feature is obtained according to the key weighted matrix and the data to be processed;
processing the N fusion features using the target computing unit based on a preset function, so as to obtain N intermediate features; and
fusing the N intermediate features with N value weighted features respectively using the target computing unit, so as to obtain N attention features corresponding to the query feature, wherein the value weighted feature is obtained according to the value weighted matrix and the data to be processed.

6. The method according to claim 3, wherein the one or more matrices to be fused comprise the key weighted matrix,
wherein the executing a plurality of attention tasks in at least one task group to be fused using a target computing unit so as to obtain a plurality of attention features comprises:
fusing a query feature with N key weighted features using the target computing unit, so as to obtain N fusion features, wherein the query feature is obtained according to a query matrix and data to be processed, and the key weighted feature is obtained according to the key weighted matrix and the data to be processed;
processing the N fusion features using the target computing unit based on a preset function, so as to obtain N intermediate features; and
fusing the N intermediate features with N value features respectively using the target computing unit, so as to obtain N attention features corresponding to the query feature, wherein the value feature is obtained according to the value matrix and the data to be processed.

7. The method according to claim 3, wherein the one or more matrices to be fused comprise the value weighted matrix,
wherein the executing a plurality of attention tasks in at least one task group to be fused using a target computing unit so as to obtain a plurality of attention features comprises:
fusing a query feature with N key features using the target computing unit, so as to obtain N fusion features, wherein the query feature is obtained according to a query matrix and data to be processed, and the key feature is obtained according to the key matrix and the data to be processed;
processing the N fusion features using the target computing unit based on a preset function, so as to obtain N intermediate features; and
fusing the N intermediate features with N value weighted features respectively using the target computing unit, so as to obtain N attention features corresponding to the query feature, wherein the value weighted feature is obtained according to the value weighted matrix and the data to be processed.

8. The method according to claim 1, wherein the obtaining a processing result using the target computing unit according to the plurality of attention features comprises:
fusing the plurality of attention features using the target computing unit, so as to obtain an attention fusion feature; and
obtaining the processing result using the target computing unit according to the attention fusion feature.

9. The method according to claim 1, wherein the matrix to be fused for the task group to be fused corresponds to N weights, M task groups to be fused are provided, and M is an integer greater than or equal to 1,
wherein the determining a loss information using the target computing unit according to the processing result comprises:
determining a task loss using the target computing unit according to the processing result and a label;
determining a plurality of parameter losses of each of the M task groups to be fused using the target computing unit according to the plurality of weights for each of the M task groups to be fused, wherein the parameter loss indicates a difference between the N weights of the matrix to be fused; and
determining the loss information using the target computing unit according to the task loss and the plurality of parameter losses.

10. The method according to claim 9, wherein the determining the loss information using the target computing unit according to the task loss and the plurality of parameter losses comprises:
fusing the plurality of parameter losses using the target computing unit, so as to obtain a parameter fusion loss;
processing the parameter fusion loss using the target computing unit according to an adjustable parameter, so as to obtain a processed parameter fusion loss; and
determining the loss information using the target computing unit according to the processed parameter fusion loss and the task loss.

11. The method according to claim 10, further comprising:
adjusting the adjustable parameter in response to determining that the loss information does not converge, and returning to execute the plurality of attention tasks in the at least one task group to be fused using the target computing unit.

12. The method according to claim 3, wherein the weighting and fusing a plurality of matrices to be fused for the at least one task group to be fused using the target computing unit according to a plurality of weights for the at least one task group to be fused so as to obtain one or more fusion matrices for at least one target task group comprises:
weighting and fusing N matrices to be fused using the target computing unit according to N weights of each of the N matrices to be fused, so as to obtain the fusion matrix for the target task group.

13. The method according to claim 12, wherein the weighting and fusing N matrices to be fused using the target computing unit comprises at least one of:
weighting and fusing N key matrices using the target computing unit according to N key weights of each of the N key matrices, so as to obtain the key fusion matrix for the target task group, wherein the key matrix is weighted by using at least one of the N key weights corresponding to the key matrix; or
weighting and fusing N value matrices using the target computing unit according to N value weights of each of the N value matrices, so as to obtain the value fusion matrix for the target task group, wherein the value matrix is weighted by using at least one of the N value weights corresponding to the value matrix.

14. The method according to claim 1, further comprising:
grouping a plurality of initial tasks using the target computing unit according to a grouping parameter, so as to obtain the at least one task group to be fused.

15. A task execution apparatus for a large model, comprising:
a storage unit; and
a target computing unit configured to:
read, from the storage unit, a plurality of matrices to be fused for at least one task group to be fused;
execute a plurality of attention tasks in the at least one task group to be fused, so as to obtain a plurality of attention features, wherein the attention task corresponds to one or more weighted matrices to be fused, and the one or more weighted matrices to be fused are obtained by weighting one or more matrices to be fused using one or more weights;
obtain a processing result according to the plurality of attention features;
determine a loss information according to the processing result;
weight and fuse a plurality of matrices to be fused for the at least one task group to be fused according to a plurality of weights for the at least one task group to be fused in response to determining that the loss information converges, so as to obtain one or more fusion matrices for at least one target task group, wherein the target task group corresponds to the task group to be fused, and a target task in the target task group is executed according to the one or more fusion matrices; and
write the fusion matrix into the storage unit to replace the plurality of matrices to be fused.

16. The apparatus according to claim 15, wherein the target computing unit is further configured to:
adjust the plurality of weights for the at least one task group to be fused in response to determining that the loss information does not converge, and return to execute the plurality of attention tasks in at least one task group to be fused.

17. The apparatus according to claim 15, wherein the one or more matrices to be fused comprise at least one of a key matrix and a value matrix, the one or more weights comprise at least one of a key weight and a value weight, the one or more weighted matrices to be fused comprise at least one of a key weighted matrix and a value weighted matrix, the key weighted matrix is obtained by weighting the key matrix using the key weight, and the value weighted matrix is obtained by weighting the value matrix using the value weight, and
wherein the one or more fusion matrices comprise at least one of a key fusion matrix and a value fusion matrix.

18. A task execution device for a large model, comprising the apparatus of claim 15.

19. An electronic device, comprising:
at least one processor; and
a memory communicatively connected to the at least one processor,
wherein the memory stores instructions executable by the at least one processor, and the instructions, when executed by the at least one processor, are configured to cause the at least one processor to at least:
execute a plurality of attention tasks in at least one task group to be fused using a target computing unit, so as to obtain a plurality of attention features, wherein the attention task corresponds to one or more weighted matrices to be fused, and the one or more weighted matrices to be fused are obtained by weighting one or more matrices to be fused using one or more weights;
obtain a processing result using the target computing unit according to the plurality of attention features;
determine a loss information using the target computing unit according to the processing result; and
weight and fuse a plurality of matrices to be fused for the at least one task group to be fused using the target computing unit according to a plurality of weights for the at least one task group to be fused in response to determining that the loss information converges, so as to obtain one or more fusion matrices for at least one target task group, wherein the target task group corresponds to the task group to be fused, and a target task in the target task group is executed by the target computing unit according to the one or more fusion matrices.

20. A non-transitory computer-readable storage medium having computer instructions stored thereon, wherein the computer instructions are configured to cause a computer to implement the method of claim 1.
